(19) United States
(12) Patent Application Publication
(10) Pub. No.: US 2026/0095534 A1
(43) Pub. Date: Apr. 2, 2026

(54) POWER SUPPLY BASE SEAT FOR PRINTER

(71) Applicant: TSC AUTO ID TECHNOLOGY CO., LTD., New Taipei City (TW)

(72) Inventors: Ko-Chun CHEN, New Taipei City (TW); Shang-Shih KUO, New Taipei City (TW); Hawk CHIANG, New Taipei City (TW); Yi-Ning CHANG, New Taipei City (TW); Chuang-Che CHUEH, New Taipei City (TW)

(21) Appl. No.: 19/024,536

(22) Filed: Jan. 16, 2025

(30) Foreign Application Priority Data
Sep. 30, 2024 (TW) 113210651

(51) Int. Cl. H04N 1/00

(52) U.S. Cl. CPC H04N 1/00907

(57) ABSTRACT

A power supply includes an adapter plate and a base unit. The adapter plate is disposed at a bottom portion of a printer, and includes a plate body, through holes extending through the plate body and corresponding in position to threaded holes of the printer, and a first assembling mechanism disposed on a bottom portion of the plate body. The through holes are configured for fasteners to extend therethrough to engage the threaded holes. The base unit is connected removably to the adapter plate, and includes a seat body, a second assembling mechanism disposed on a top portion of the seat body and configured to be removably assembled to the first assembling mechanism, and a power module disposed on the seat body and used to supply power to the printer. The power module includes at least one power supply port for connection with the power connector of the printer.

### CROSS-REFERENCE TO RELATED APPLICATION

This application claims priority to Taiwanese Utility Model Patent Application No. 113210651, filed on Sep. 30, 2024, the entire disclosure of which is incorporated by reference herein.

### FIELD

The disclosure relates to a base seat, and more particularly to a power supply base seat for a printer.

### BACKGROUND

As the internet develops, a printer (e.g., a label printer) may be connected to a mobile phone for printing documents or labels. There is an increasing need for printers as such to be moved around in location; however, the extent to which they can be moved around are often restricted by their power supplies.

### SUMMARY

Therefore, an object of the disclosure is to provide a power supply base seat that can alleviate at least one of the drawbacks of the prior art.

According to the disclosure, the power supply base seat is adapted to be mounted to a printer. The printer includes a plurality of threaded holes located at a bottom portion of the printer and a power connector. The power supply includes an adapter plate and a base unit.

The adapter plate is adapted to be disposed at the bottom portion of the printer. The adapter plate includes a plate body, a plurality of through holes that extend through the plate body in an up-down direction and that at least correspond in position to the plurality of threaded holes, and a first assembling mechanism that is disposed on a bottom portion of the plate body. The plurality of through holes are configured for a plurality of fasteners to extend therethrough to engage the plurality of threaded holes of the printer.

The base unit is connected removably to the adapter plate. The base unit includes a seat body, a second assembling mechanism that is disposed on a top portion of the seat body and that is configured to be removably assembled to the first assembling mechanism, and a power module that is disposed on the seat body and that is used to supply power to the printer. The power module includes at least one power supply port for connection with the power connector of the printer.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic side view of a first embodiment of a power supply base seat for a printer according to the present disclosure installed with the printer.

FIG. 2 is a perspective view of the first embodiment.

FIG. 3 is a partly exploded perspective view of the first embodiment.

FIG. 4 is a partly exploded perspective view of the first embodiment taken from another angle.

FIG. 5 is a perspective view of an operation button and two engaging hooks of the first embodiment.

FIG. 6 is a top view of the first embodiment, illustrating a second assembling mechanism of a base unit in a locked state.

FIG. 7 is a fragmentary sectional view of the first embodiment, illustrating the second assembling mechanism of the base unit in the locked state.

FIG. 8 is a top view of the first embodiment, illustrating the second assembling mechanism of the base unit in an unlocked state.

FIG. 9 is a fragmentary sectional view of the first embodiment, illustrating the second assembling mechanism of the base unit in the unlocked state.

FIG. 10 is a perspective view of a second embodiment of the power supply base seat for a printer according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

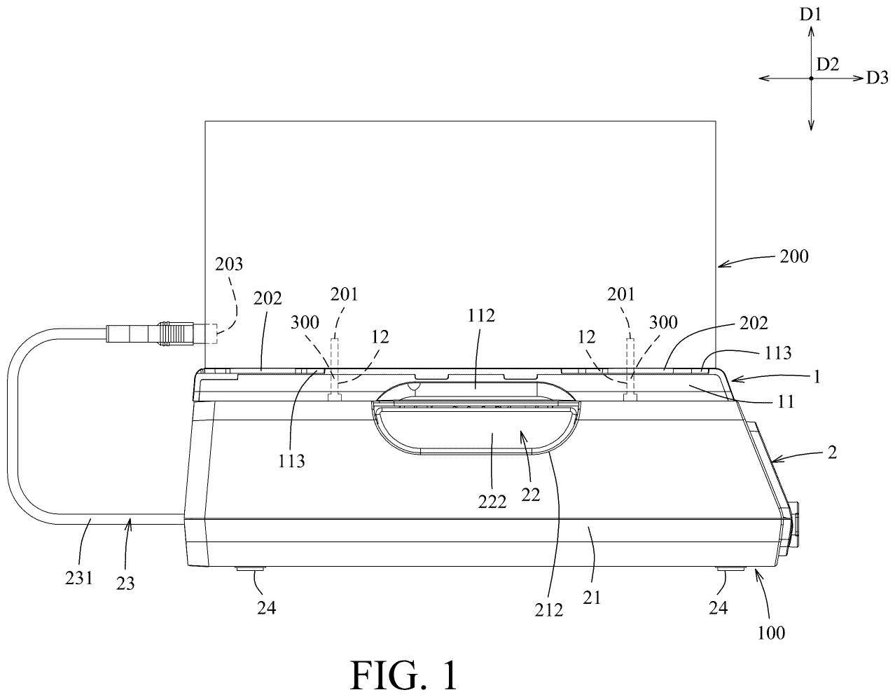

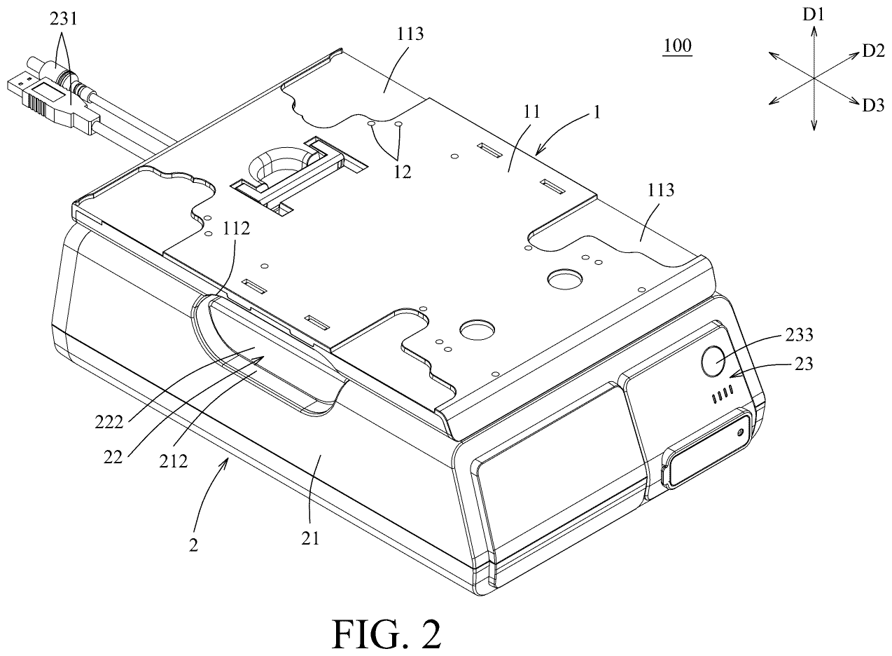

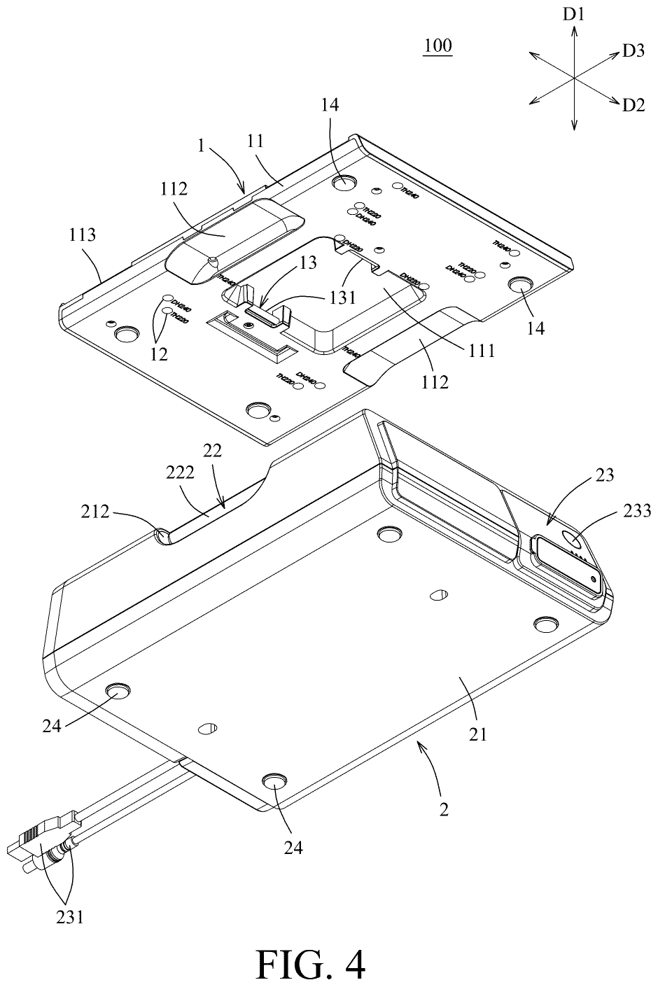

Referring to FIGS. 1 to 4, a first embodiment of a power supply base seat 100 according to the present disclosure is adapted to be mounted to a printer 200 which includes a plurality of threaded holes 201 that are located at a bottom portion thereof, a plurality of foot pads 202 that are located at the bottom portion thereof, and a power connector 203. The power connector 203, for example, is a USB port. In the first embodiment, the power supply base seat 100 is adapted to be mounted to a selected one of various printers 200. An assembly of the power supply base seat 100 and a selected one of the printers 200 is described hereinafter. The power supply base seat 100 includes an adapter plate 1 and a base unit 2.

The adapter plate 1 is disposed on the bottom portion of the printer 200 in a top-bottom direction (D1). The adapter plate 1 includes a plate body 11, a plurality of through holes 12 that extend through the plate body 11 in the top-bottom direction (D1) and that at least partially correspond in position to the threaded holes 201, a first assembling mechanism 13 that is disposed on a bottom portion of the plate body 11, and a plurality of adapter plate foot pads 14 that are disposed on the bottom portion of the plate body 11. The plate body 11 has an alignment groove 111 that is proximate to the bottom portion thereof and faces downward, two bottom grooves 112 that are located at the bottom portion thereof and recessed inwardly in a left-right direction (D2) (a first transverse direction), and a plurality of first foot pad receiving recesses 113 that are located at a top portion thereof and used to receive the foot pads 202 of the printer 200 therein. The through holes 12 are configured for a plurality of fasteners 300 to extend therethrough to engage the threaded holes 201 of the printer 200. The power supply base seat 100 is adapted to be mounted to the selected one of the printers 200, so that the through holes 12 in the adapter plate 1 are at least partially aligned with the threaded holes 201 of the selected model of the printers 200, and the first foot pad receiving recesses 113 in the plate body 11 of the adapter plate 1 are configured to receive the foot pads 202 of the selected one of the printers 200. Moreover, in this embodiment, a model number of each suitable model of the printers 200 is written next to corresponding ones of the through holes 12 of the adapter plate 1.

The first assembling mechanism 13 is disposed in the alignment groove 111, and the first assembling mechanism 13 includes two assembly posts 131 that are disposed in the alignment groove 111. The assembly posts 131 extend in the left-right direction (D2) and are spaced apart from each other in a front-rear direction (D3) (a second transverse direction). The left-right direction (D2) and the front-rear direction (D3) are perpendicular to each other. The adapter plate foot pads 14 serve to provide a cushioning and shock-absorbing effect so that the printer 200 may be directly disposed on a desk or other surfaces after being threadedly engaged with the adapter plate 1.

The base unit 2 is removably connected to the adapter plate 1, and includes a seat body 21, a second assembling mechanism 22 that is disposed at a top portion of the seat body 21 and configured to be removably assembled to the first assembling mechanism 13, a power module 23 that is disposed on the seat body 21 and used to supply power to the printer 200, and a plurality of pedestal foot pads 24 that are disposed on a bottom portion of the seat body 21. The seat body 21 has an alignment protrusion 211 that is engageable with the alignment groove 111, two top grooves 212 that are located at the top portion thereof and recessed inwardly in the left-right direction (D2), and a plurality of second foot pad receiving recesses 213 that are adapted for receiving the adapter plate foot pads 14. The top grooves 212 of the seat body 21 correspond in position to the bottom grooves 112 of the plate body 11, respectively. The top grooves 212 of the seat body 21 and the bottom grooves 112 of the plate body 11 allow a user to extend his/her hand between the adapter plate 1 and the base unit 2 to facilitate separation of the adapter plate 1 from the base unit 2.

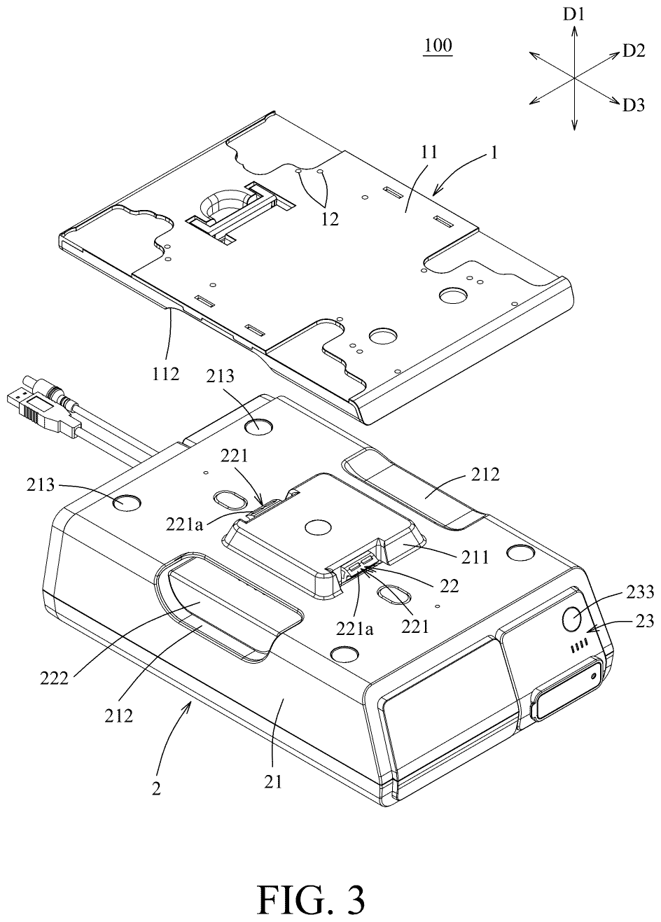

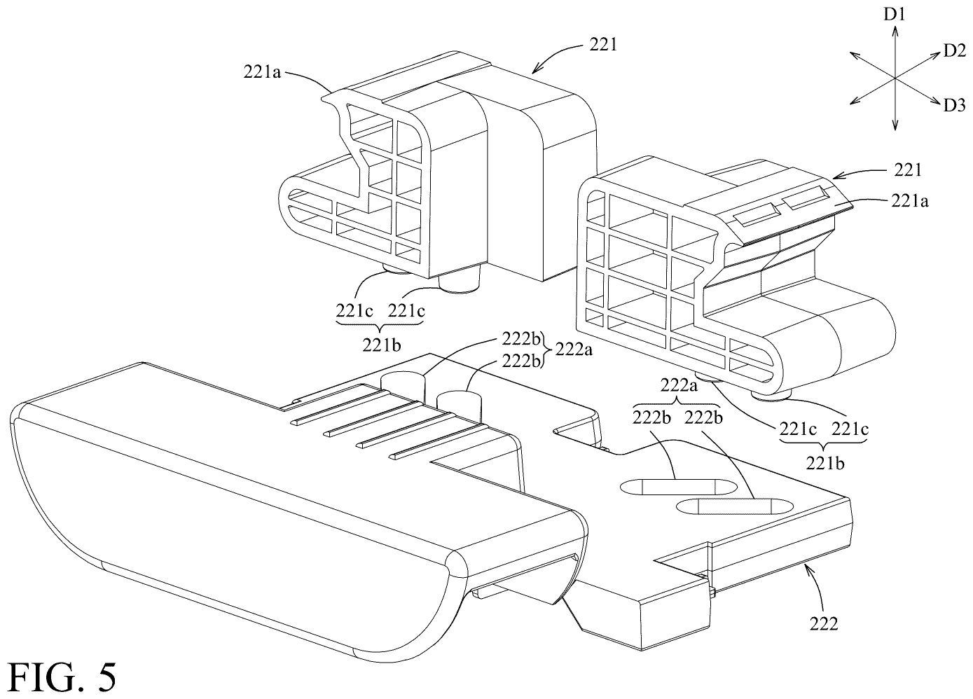

Referring to FIGS. 3 to 6, the second assembling mechanism 22 is disposed on the alignment protrusion 211, and is switchable between a locked state and an unlocked state. The second assembling mechanism 22 includes two engaging hooks 221 that are disposed on the alignment protrusions 211, that are movable in the front-rear direction (D3) and that are spaced apart from each other in the front-rear direction (D3), an operation button 222 that is disposed on the seat body 21, that is movable in the left-right direction (D2) and that is at least partially exposed from the seat body 21 in the left-right direction (D2), and a plurality of resilient members 223 that are located between the seat body 21 and the operation button 222. The operation button 222 is exposed at least partially from one of the top grooves 212 of the seat body 21 in the left-right direction (D2). The operation button 222 includes two slide groove sets 222a that extend obliquely and that respectively correspond to the engaging hooks 221. Each of the slide groove sets 222a includes two slide grooves 222b. Each of the engaging hooks 221 has a hook protrusion 221a that protrudes outwardly in the front-rear direction (D3), and a slide block set 221b that is slidably disposed on a corresponding one of slide groove sets 222a. Each of the slide block sets 221b includes two slide blocks 221c.

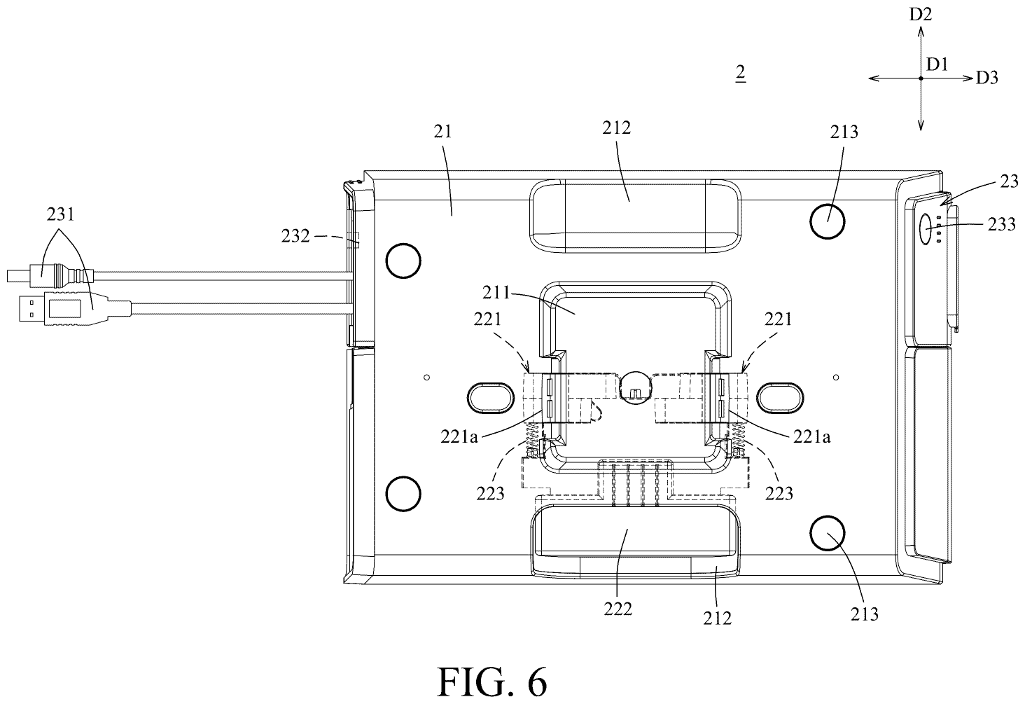

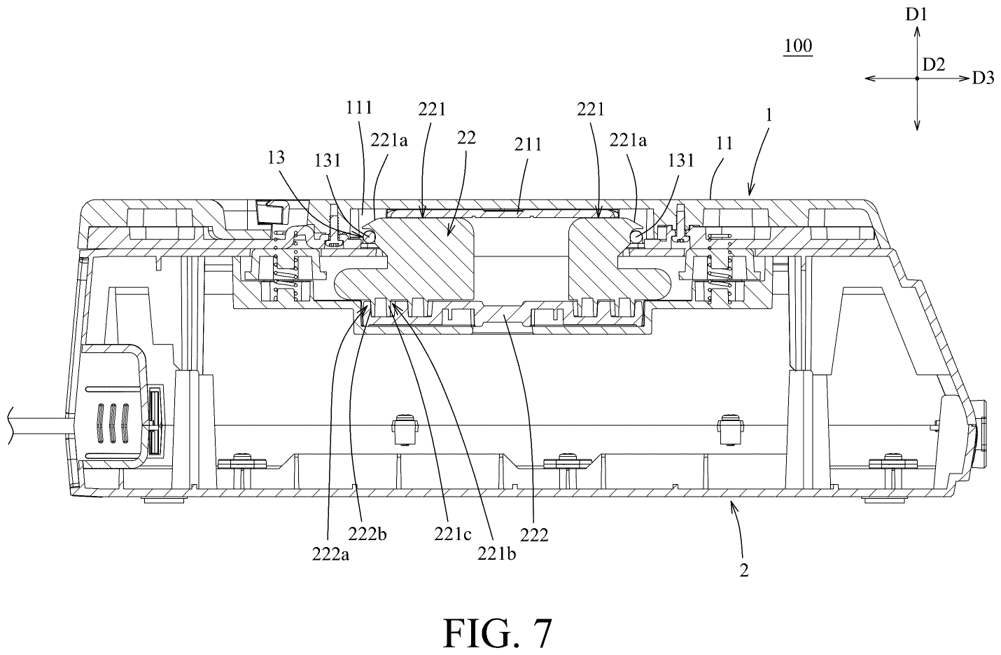

Referring to FIGS. 6 to 7, when the second assembling mechanism 22 is in the locked state, the operation button 222 protrudes relative to the seat body 21 into the one of the top grooves 212 in the left-right direction (D2), thereby making the engaging hooks 221 move away from each other in the front-rear direction (D3) (i.e., being respectively distal from each other). The hook protrusions 221a of the engaging hooks 221 respectively engage the assembly posts 131 to prevent upward movement of the assembly posts 131 so that the adapter plate 1 is fixed to the base unit 2.

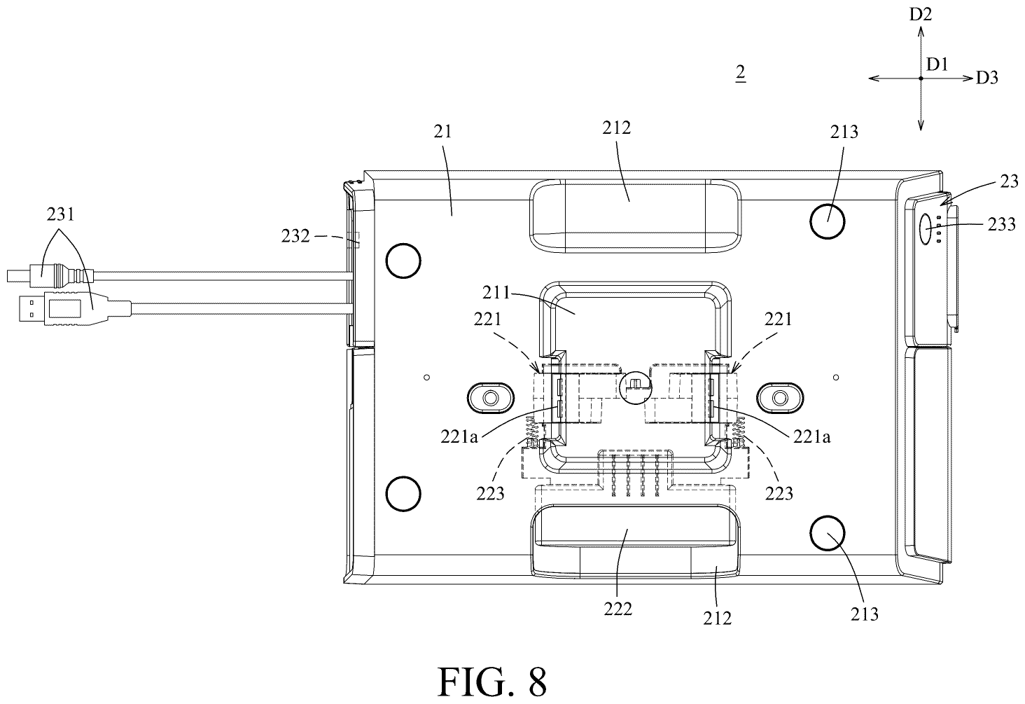

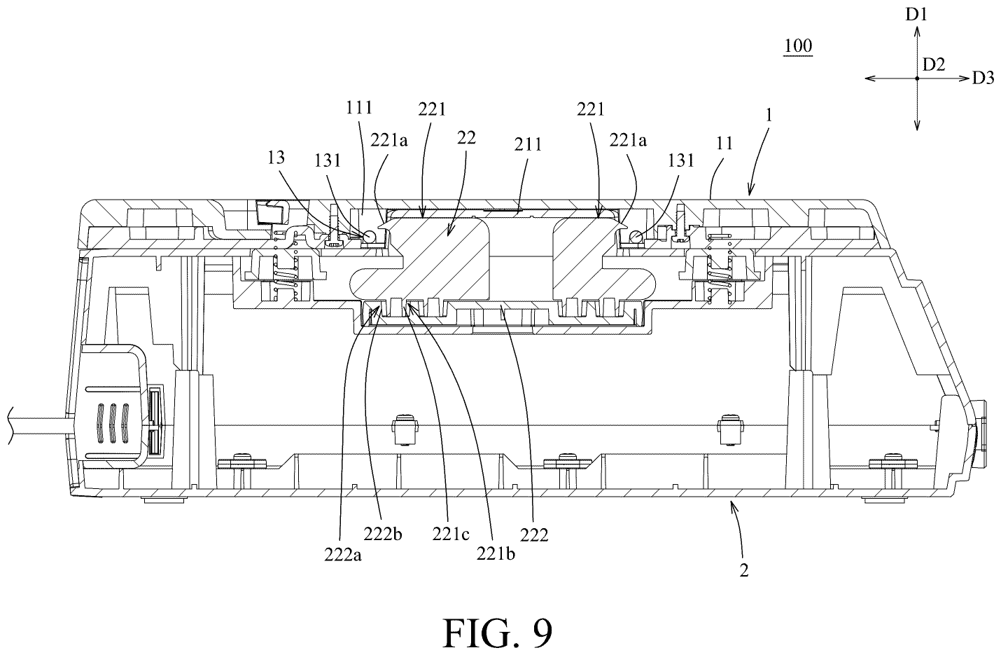

Referring to FIGS. 8 to 9, when the second assembling mechanism 22 is in the unlocked state, the operation button 222 is retracted into the seat body 21 in the left-right direction (D2), thereby making the engaging hooks 221 move toward each other in the front-rear direction (D3). The hook protrusions 221a of the engaging hooks 221 respectively release the assembly posts 131 to allow the assembly posts 131 to move upwardly so as to permit disengagement of the adapter plate 1 from the base unit 2.

The resilient members 223 are used to drive the operation button 222 to protrude into the one of the top grooves 212 in the left-right direction (D2) such that the second assembling mechanism 22 is the locked state, thereby preventing the adapter plate 1 from moving away from the base unit 2 under an abnormal external force or an improper operation.

Specifically, the number of the adapter plate 1 may be multiple (i.e., the adapter plate 1 may include a plurality of adapter plates 1). The adapter plates 1 may be respectively disposed on the printers 200 (see FIG. 1). By virtue of the first assembling mechanism 13 of the adapter plate 1 and the second assembling mechanism 22 of the base unit 2, the one of the printers 200 disposed on the base unit 2 may be quickly switched.

Referring to FIGS. 3, 4 and 6, the power module 23 includes a plurality of power supply ports 231 for connection with the power connector 203 of the printer 200, a charging port 232 for charging, and a power button 233. In the first embodiment, the power supply ports 231 include a USB port and a DC connector.

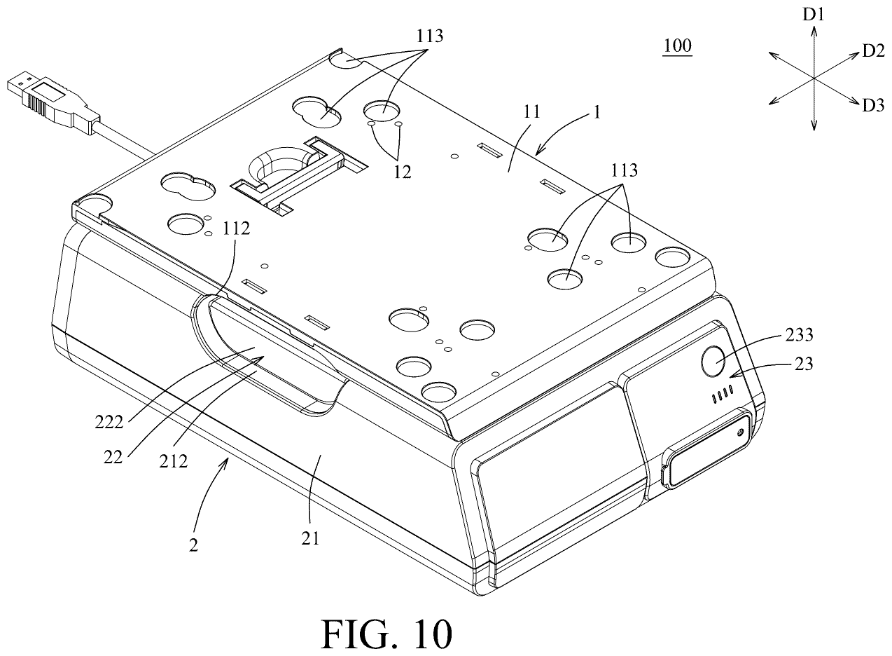

Referring to FIG. 10, a second embodiment of the power supply base seat 100 according to the present disclosure differs from the first embodiment. In the first embodiment, at least one of the first foot pad receiving recesses 113 of the adapter plate 1 is greater in size and may receive a plurality of the foot pads 202 of each different model of the printers 200. In the second embodiment, however, each of the first foot pad receiving recesses 113 of the adapter plate 1 is used for receiving a single one of the foot pads 202 of the printers 200.

In summary, the power supply base seat 100 according to the present disclosure may stably serve as a base for the printer 200 and supply power to the printer 200, so that the position of the printer 200 is not limited by the power source, thereby satisfying the need of moving the printer 200 around conveniently. Moreover, by virtue of the adapter plate 1 that is threadedly engaged to the printer 200 and that is removably assembled to the base unit 2, the printer 200 that is threadedly engaged to the adapter plate 1 may be used independently or with the base unit 2 as required.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A power supply base seat adapted to be mounted to a printer, the printer including a plurality of threaded holes located at a bottom portion of the printer and a power connector, said power supply comprising:
an adapter plate adapted to be disposed at the bottom portion of the printer, said adapter plate including a plate body, a plurality of through holes that extend through said plate body in an up-down direction and that at least correspond in position to the plurality of threaded holes, and a first assembling mechanism that is disposed on a bottom portion of said plate body, said plurality of through holes configured for a plurality of fasteners to extend therethrough to engage the plurality of threaded holes of the printer; and
a base unit connected removably to said adapter plate, said base unit including a seat body, a second assembling mechanism that is disposed on a top portion of said seat body and that is configured to be removably assembled to said first assembling mechanism, and a power module that is disposed on said seat body and that is used to supply power to the printer, said power module including at least one power supply port for connection with the power connector of the printer.

2. The power supply base seat) as claimed in claim 1, wherein said plate body of said adapter plate has an alignment groove that is proximate to said bottom portion thereof and that faces downward, said first assembling mechanism being disposed in said alignment groove, said seat body of said base unit having an alignment protrusion that is engageable with said alignment groove, said second assembling mechanism being is disposed on said alignment protrusion.

3. The power supply base seat as claimed in claim 2, wherein said first assembling mechanism includes two assembly posts that are disposed in said alignment groove, said two assembly posts extending in a first transverse direction and being spaced apart from each other in a second transverse direction, the first transverse direction and the second transverse direction being perpendicular to each other, said second assembling mechanism being switchable between a locked state and an unlocked state, said second assembling mechanism including two engaging hooks that are disposed on said alignment protrusion, that are movable in the second transverse direction, and that are spaced apart from each other in the second transverse direction, each of said engaging hooks having a hook protrusion that protrudes outwardly in the second transverse direction, said engaging hooks being respectively distal from each other in the second transverse direction and said hook protrusions of said engaging hooks respectively engaging said assembly posts to prevent upward movement of said assembly posts when said second assembling mechanism is in the locked state, said engaging hooks moving toward each other in the second transverse direction and said hook protrusions of said engaging hooks respectively releasing said assembly posts to allow said assembly posts to move upwardly when said second assembling mechanism is in the unlocked state.

4. The power supply base seat as claimed in claim 3, wherein said second assembling mechanism further includes an operation button that is movable in the first transverse direction and that is at least partially exposed from said seat body in the first direction, and at least one resilient member that is located between said seat body and said operation button, said operation button including two slide grooves that extend obliquely and that respectively correspond to said engaging hooks, each of said engaging hooks further including a slide block that is slidably disposed on a respective one of said slide grooves, when said second assembling mechanism is in the locked state, said operation button protruding relative to said seat body in the first transverse direction, thereby making said engaging hooks move away from each other in the second transverse direction, when said second assembling mechanism is in the unlocked state, said operation button being retracted into said seat body in the first transverse direction, thereby making said engaging hooks move toward each other in the front-rear direction, said resilient member being used to drive said operation button to protrude relative to said seat body in the first transverse direction such that said second assembling mechanism is in the locked state.

5. The power supply base seat as claimed in claim 4, wherein said seat body includes two top grooves that are located at said top portion thereof and that are recessed inwardly in the first transverse direction, said operation button protruding at least partially into one of said top grooves in the first transverse direction.

6. The power supply base seat as claimed in claim 5, wherein said plate body includes two bottom grooves that are located at said bottom portion thereof and that are recessed inwardly in the first transverse direction, said top grooves of said seat body corresponding in position to said bottom grooves of the plate body, respectively.

7. The power supply base seat as claimed in claim 1, the printer further includes a plurality of foot pads that are located on the bottom portion thereof, wherein said plate body of said adapter plate further including a plurality of first foot pad receiving recesses for receiving said foot pads therein.

8. The power supply base seat as claimed in claim 1, wherein said adapter plate further includes a plurality of adapter plate foot pads that are disposed on said bottom portion of said plate body, said seat body of said base unit further including a plurality of second foot pad receiving recesses for respectively receiving said adapter plate foot pads therein.

9. The power supply base seat as claimed in claim 1 adapted to be mounted to a selected one of various printers each of which includes a plurality of threaded holes, wherein said plurality of through holes of said adapter plate are at least partially aligned with the plurality of threaded holes of the selected one of the printers.

10. The power supply base seat as claimed in claim 7 adapted to be mounted to a selected one of various printers each of which includes a plurality of foot pads, wherein at least a portion of said first foot pad receiving recesses of said plate body of said adapter plate receive said plurality of foot pads of the selected one of the printers.
